(19) United States
(12) Patent Application Publication
(10) Pub. No.: US 2011/0285656 A1
(43) Pub. Date: Nov. 24, 2011

(54) Sliding Motion To Change Computer Keys

(75) Inventors: Jeffrey D. Yaksick, Sunnyvale, CA (US); Amith Yamasani, San Jose, CA (US)

(73) Assignee: Google Inc.

(21) Appl. No.: 13/111,787

(22) Filed: May 19, 2011

Related U.S. Application Data
(60) Provisional application No. 61/346,374, filed on May 19, 2010.

(51) Int. Cl. G06F 3/041

(52) U.S. Cl. 345/173

(57) ABSTRACT

The subject matter of this specification can be implemented in, among other things, a computer-implemented touch screen user interface method that includes displaying a plurality of keys of a virtual keyboard on a touch screen computer interface, wherein the keys each include initial labels and a first key has multi-modal input capability that include a first mode in which the key is tapped and a second mode in which the key is slid across. The method further includes identifying an occurrence of sliding motion in a first direction by a user on the touch screen and over the first key. The method further includes determining modified key labels for at least some of the plurality of keys. The method further includes displaying the plurality of keys with the modified labels in response to identifying the occurrence of sliding motion on the touch screen and over the first key.

### CROSS-REFERENCE TO RELATED APPLICATION

This application claims priority to U.S. Provisional Application Ser. No. 61/346,374, filed on May 19, 2010, entitled “Sliding Motion to Change Computer Keys,” the entire contents of which are hereby incorporated by reference.

### TECHNICAL FIELD

This document relates to user interfaces for computing devices such as mobile devices in the form of smart phones.

### BACKGROUND

People spend more and more time communicating through computing devices. Many jobs require that an employee use a computer. Many people also surf the web, listen to or watch digital music or video files at home, or perform other personal pursuits via computers, and particularly small mobile computers. Also, with the development of smarter and more capable mobile devices, such as smart phones, many more people use computers while moving about. Users of such devices may now access various services on the internet, such as mapping applications, electronic mail, text messaging, various telephone services, general web browsing, music and video viewing, and similar such services.

The small size of mobile devices may make it difficult to interact with such services. In certain instances, a mobile device that has a touch screen can provide a virtual keyboard whereby the image of keys for a keyboard is shown on a screen of the device, and user taps on areas of the touch screen that overlay particular keys on the keyboard cause the taps to be interpreted by the device as user selections of the spatially corresponding keys.

### SUMMARY

This document describes systems and techniques that a user may employ in order to enter information into a mobile or other computing device, particular via an on-screen, or virtual, keypad. Such virtual keypads are frequently provided on mobile touch screen devices, as on-screen virtual QWERTY keyboards or other forms of keyboards.

In general, a computing device may provide different sets of labels on the keys of a virtual keyboard, such as when a user switches from alphabetic character entry to numeric or symbol entry, or when a user switches languages. As one example, when a user is typing in Cyrillic and the user wants to type the proper name of an English-language friend, the user may need to switch to an English-language Roman character keyboard such as a standard QWERTY keyboard. In such a situation, the user may slide their finger (or other pointer, such as a stylus) across a key that would otherwise register a character input if the user were to tap on the key. Such sliding across the keyboard may then be interpreted as an intent by the user to switch the labels on the keys, and such a change may be implemented by the device automatically in response to the sliding. The particular key that may be selected by the user in such an instance may be the space bar, since that key is particularly wide, and thus accepting of lateral sliding motion, though sliding off the edge of a key may be interpreted by the device as a continuation of a sliding motion that began on top of the key.

In certain embodiments, the features discussed here may provide one or more advantages. For example, a user can enter data in multiple modes easily without having to complete an ungainly number of operations. The implementation may also occur by using an input method editor (IME) that manages a virtual keyboard and converts various inputs from different input modes into a common output for applications, so that application developers need not worry about the different ways in which users may provide input to a device. Also, in some situations, where multiple fingers can be applied to a screen at once, the sliding input can be combined with a tap for entering a character, and then the keyboard can be quickly returned to its original state, such as by lifting the sliding finger.

In one aspect, a computer-implemented user interface method for a computing device is discussed. The method includes displaying a plurality of keys of a virtual keyboard on a touch screen computer interface, wherein the keys each include initial labels and a first key has multi-modal input capability that include a first mode in which the key is tapped and a second mode in which the key is slid across. The method further includes identifying an occurrence of sliding motion in a first direction by a user on the touch screen and over the first key, determining modified key labels for at least some of the plurality of keys, and displaying the plurality of keys with the modified labels in response to identifying the occurrence of sliding motion on the touch screen and over the first key.

Implementations can optionally include one or more of the following features. For example, a transition from the initial labels to the revised labels may be animated while the sliding motion occurs. The animated transition can include wiping the initial labels off the keys as the sliding motion progresses, while maintaining outlines for the keys stationary. Further, the animated transition can include wiping the modified labels onto the keys as the initial labels are wiped off the keys. The animated transition can also include visually rotating each of the keys (e.g., about a vertical axis through the middle of each key) to visually change from first surfaces of the keys displaying the initial labels to second surfaces of the keys displaying the modified labels.

The method may also include determining which axis, of a plurality of axes, the sliding motion is occurring along, and selecting a group of modified labels based on the determination of which axis the sliding motion is occurring along. Moreover, the method can comprise selecting a group of modified labels that is primarily non-alphabetic labels if the sliding motion is determined to occur along a first axis, and selecting a group of modified labels that is primarily alphabetic labels if the sliding motion is determined to occur along a second axis that is different than the first axis. In other aspects, the method can include displaying, near the first key and while identifying the occurrence of a sliding motion, an icon that describes a label type to be applied to the plurality of keys if the sliding motion were to stop immediately. The method may additionally include identifying an occurrence of sliding motion in a direction opposite the first direction, and, as a result, displaying the plurality of keys with the initial labels. The method can further include initial labels represent characters in a first language and the modified labels represent characters in a second language.

Furthermore, the method can include determining which axis, of a plurality of axes, the sliding motion is occurring along, and selecting a group of modified labels based on the determination of which axis the sliding motion is occurring along. Selecting a group of modified labels that is primarily non-alphabetic labels if the sliding motion is determined to occur along a first axis, and selecting a group of modified labels that is primarily alphabetic labels if the sliding motion is determined to occur along a second axis that is different than the first axis. The method can also include displaying, near the first key and while identifying the occurrence of a sliding motion, an icon that describes a label type to be applied to the plurality of keys if the sliding motion were to stop immediately.

Further, the method can include identifying an occurrence of sliding motion in a direction opposite the first direction, and, as a result, displaying the plurality of keys with the initial labels. Initial labels can represent characters in a first language and the modified labels can represent characters in a second language. The method can also include providing a tactile feedback to register, with the user, reception of the sliding motion as a recognized keyboard-changing input. In other aspects, the method comprises coordinating data for providing sliding input on keys of a first computing device that corresponds to a user account, with data for providing hot-key input on corresponding keys of a second computing device that corresponds to the user account.

In another implementation, a computer-implemented touch screen interface system is described that has a touch screen to display on a mobile computing device a virtual keyboard having a plurality of keys. The system further includes an input manager to receive and interpret user inputs on a touchscreen of a computing device, including tapping inputs and dragging inputs, and a gesture interface programmed to interpret a tapping input on a first one of the keys as a user intent to enter a character currently being displayed on the touch screen on the first one of the keys, and to interpret a dragging input across the first one of the keys as a user intent to change labels on at least some of the keys.

Implementations can include optionally include one or more of the following features. The gesture interface can be further programmed to determine which axis, of a plurality of axes, the sliding motion is occurring along, and to select a group of modified labels based on the determination of which axis the sliding motion is occurring along. The gesture interface can also be programmed to select a group of modified labels that is primarily non-alphabetic labels if the sliding motion is determined to occur along a first axis, and to select a group of modified labels that is primarily alphabetic labels if the sliding motion is determined to occur along a second axis that is different than the first axis. Further, the gesture interface can be programmed to cause a display interface to cause an animated transition to be provided during a dragging motion on the first one of the keys, showing a change from a first set of labels on at least some of the plurality of keys to a second, different set of labels on the at least some of the plurality of keys.

The transition can include wiping the initial labels off the keys as the sliding motion progresses, while maintaining outlines for the keys stationary. The transition can further include visually rotating each of the keys to visually changed from first surfaces of the keys displaying the initial labels to second surfaces of the keys displaying the modified labels. The gesture interface can furthermore be programmed to cause a display, near the first one of the keys and during a dragging input, of an icon that describes a label type to be applied to the plurality of keys if the dragging motion were to stop immediately.

In yet another implementation, a computer-implemented touch screen user interface system is disclosed that includes a touch screen to display on a mobile computing device a virtual keyboard having a plurality of keys. The system further includes an input manager to receive and interpret user inputs on a touchscreen of a computing device, including tapping inputs and dragging inputs, and means for changing a display of labels on the plurality of keys in response to sensing a dragging motion across one of the plurality of keys.

The details of one or more embodiments are set forth in the accompanying drawings and the description below. Other features and advantages will be apparent from the description and drawings, and from the claims.

### DESCRIPTION OF DRAWINGS

FIGS. 1A and 1B show a progression of example screenshots of a mobile computing device providing for touchscreen user input.

FIG. 2 is a block diagram of a system for providing touchscreen user keyboard input.

FIG. 3 is a flowchart of a process for receiving touchscreen user inputs.

FIG. 4 is a swim lane diagram of a process by which a gesture tracking module interfaces between a computer application and a touchscreen.

FIG. 5 shows an example of a computer device and a mobile computer device that can be used to implement the techniques described here.

Like reference symbols in the various drawings indicate like elements.

### DETAILED DESCRIPTION

This document describes systems and techniques for receiving user input on a touchscreen of a computing device in a manner that indicates a change from one input type to another. A user who wishes to enter characters that are not currently available on an on-screen virtual keyboard slides a finger (or other physical pointer, like a stylus) across a particular key on the keyboard to change the labels on the keyboard keys. On the keys, for example, letters can be changed to numbers and special characters, or a keyboard for a new language can replace the current keyboard. Alternatively, a QWERTY keyboard can be replaced with a keypad of programmable keys. In making the change of labels, the key outlines may stay fixed in position while the uses slides his or her finger, and the labels on the keys may be changed.

The particular sliding motion on a key may alternatively or in addition cause the execution of a command, macro, or other set of commands associated with a particular key on which the sliding occurs. For example, sliding on the “S” key in a particular direction can cause the text of the user's signature to be entered on the screen of a device. Some macros can be associated with the currently active application (e.g., send current email when in email, versus signature when in a word processing application), and some macros can be associated with other applications and with frequently used tasks (e.g., place a call to a contact, launch an application).

The user sliding motion can be interpreted based on where the contact and motion starts, where it ends, and areas that are passed. In particular, the keyboard key or keys that fall under any such area may represent an anchor point for the command or other input. For example, a dragging or sliding motion across a spacebar can indicate a request for a different language keyboard. A sliding input moving from the bottom of the keyboard to the top can indicate a request to scroll the current keyboard up and away and load a new keyboard from the bottom. A swipe starting on a key labeled “M” can indicate a request for a macro keypad. A swipe starting at a letter key and moving in a predetermined direction can indicate a key press with a modifier key (e.g., control, alt). Also, while certain inputs may be reserved for changing labels on the keys, other inputs may take more traditional forms, such as sliding downward on a keyboard in order to hide it off the bottom of a screen.

Keyboard settings that relate to which commands relate to which keys on a keyboard can be set in an online user account, and can be synchronized to a mobile device. In particular, a user may have assigned certain hot key combinations on their home PC, and such combinations may be translated as operations invoke by sliding on the corresponding keys on a virtual keyboard. For example, a user may have assigned CTRL-C on a keyboard to the copy command, and that command may be invoked on their mobile device, after they have synchronized the devices through their on-line account, by contacting the “S” key and dragging to the right (or another pre-set direction).

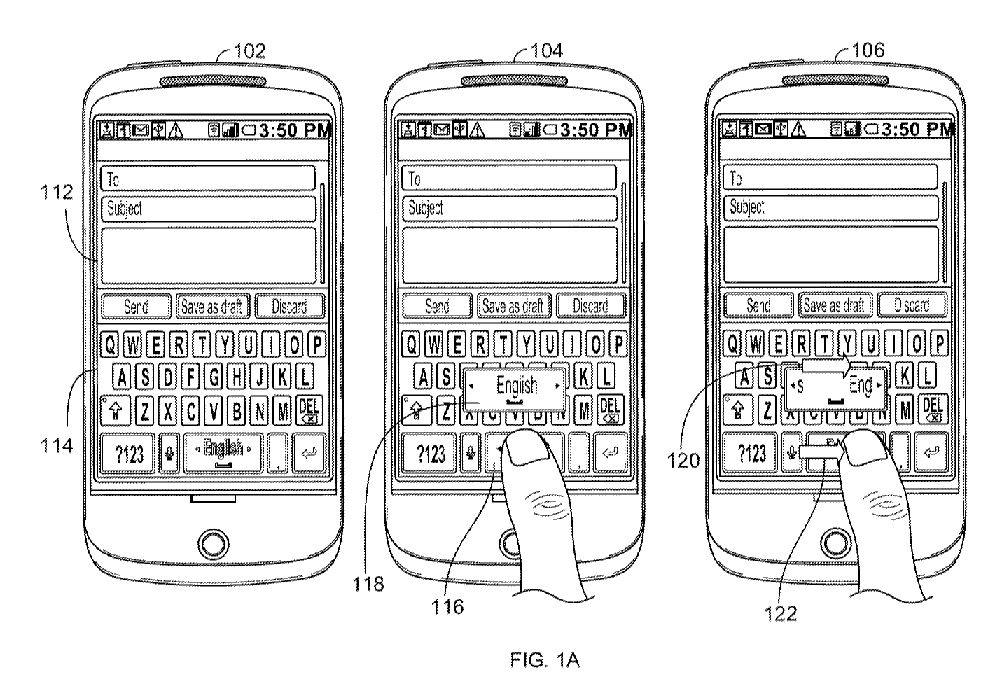

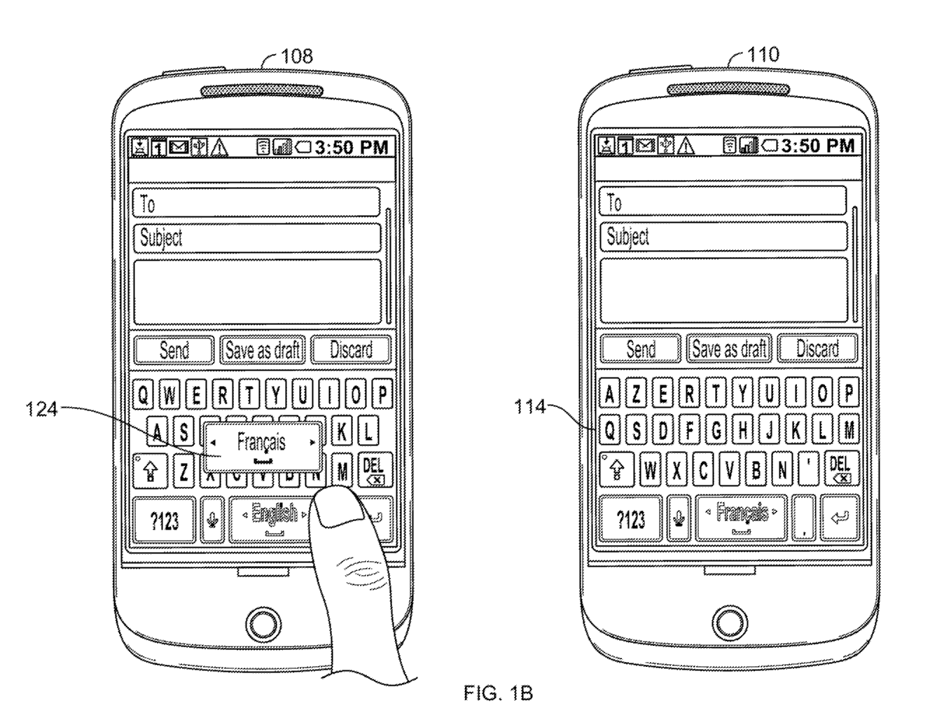

FIGS. 1A and 1B show a progression of example screenshots of a mobile computing device providing for touchscreen user input. In general, the screenshots show a user employing sliding contact input motions on a virtual keyboard in order to switch the labels on the keyboard from one language to another language.

At screenshot 102, an on-screen virtual keyboard is displayed to a user of a computing device. The keyboard is displayed along with fields for an electronic mail message, because the user is currently composing a message. The virtual keyboard may have been invoked automatically by the device when the user chose to start a new message, under the assumption that the user would want to provide textual input in such a situation. The keyboard may be provided as part of a service from an operating system on the device, so that the author of the email application can simply access the keyboard functionality through an API, and need not have implemented their own virtual keyboard.

In normal operation, the user can tap the keys on the keyboard to send text input to the selected text input field, character by character. Typing input can be recognized in known manners as contacts by a pointer with the screen, where the contacts take less than a determined amount of time between initiation of the contact and the end of the contact. The taps are to be contrasted with sliding or dragging motions, and long press inputs, each of which can be distinguished from each other using familiar techniques.

The user can slide or swipe on the keyboard to cause an alternative keyboard to be displayed on the virtual keyboard. For example, the user may wish to access a keyboard with a number pad, macros, stored text strings, Roman characters in a different layout, or non-Roman characters. To make such a transition, the user can place a finger on the left side of the space bar and begin swiping to the right. While the user is providing such input, a window that is displayed over the virtual keyboard can display a list of keyboard options, and the user can stop swiping when the desired option is displayed. The window generally provides contextual visual feedback to the user that indicates to the user the status of their input with respect to the change that will take effect if the user lifts the pointer at the current point in time.

In screenshot 102, the mobile computing device displays an email application with a text input field 112 and an English QWERTY keyboard 114. When the user selects the text input field 112, the default input method editor (IME) is loaded, in this case the QWERTY keyboard 114. The user can tap keys on the QWERTY keyboard 114 to enter English Roman characters in the text input field 112, in a familiar and well-known manner. The spacebar of the keyboard 114 has a label that displays the type of keyboard currently being shown to the user, in this case an English keyboard. As can be seen, however, the keyboard has space to display little more than the Roman alphabet and a handful of control keys.

In screenshot 104, the user has begun swiping across a key 116—here, the spacebar—from left to right. The swipe can be used to determine that the user want to switch keyboards by transitioning the labels on the keys of the keyboard. A tap by the user, instead of a swipe, can be used to determine that the user wants to interact with the key 116 in a normal manner to submit to the active application the label on the key (e.g., sending text such as a space character to the selected text input field 112).

As the user starts to slide on the spacer bar, the system recognizes the user input as a sliding input rather than a tapping input and thus recognizes that the user intends a special input rather than simply to submit a space character. An IME selection window 118 is displayed to the user as a result. The IME selection window displays one label that indicates a current language that would be selected for the keyboard if the user were to lift his or her finger. The user may establish multiple keyboards that are available to them when they configure their device, so that the keyboards they can select are specific to their capabilities. For example, a scientist may request a keyboard with Latin characters, while users of various nationalities may select keyboards that display the particular characters of their native language.

In screenshot 106, the label in the window scrolls 120 in coordination with the user sliding his or her finger, so that the user can obtain feedback regarding what will happen if he or she lifts her finger. The user can extend the swiping input to move across multiple keyboard in one selection, e.g., if the user has configured the device to include three or more keyboards. In some examples, only the next keyboard in the list may be selected, and multiple swipes can be required to scroll through many IME options.

In screenshot 108, the user ends the swipe, indicating a selection of the Français label 124 that are currently displayed in the window. As shown, the user's swipe ends off of the spacebar key where it started. In this implementation, only the starting position and distance of the swipe is used to identify the desired keyboard labels. To continue scrolling, the user could continue swiping in any direction: around the border of the keyboard, in a zigzag or a circle. Swiping backward (i.e., right to left) along the swipe path can indicate the selection window should scroll backward. The selection of the new labels can be triggered by a pointer up event on the touch screen.

In the screenshot 110, the Français keyboard 114 is shown. The IME displaying the keyboard 114 can then interpret user taps of keys as commands for text input. The label on the spacebar of the keyboard 114 has also changed to show the current language being display on the keys.

The device in these screenshots has at least two user selectable keyboards, and a label is always shown on each keyboard so that a user can quickly identify which keyboard is in use. For devices that are configured with a single keyboard, the label may be suppressed if the keyboard is the same language as the current application or device default, and may be shown if the keyboard is a different language than standard.

The changing of labels on the keyboard may be complete or partial. For example, when changing from one language to another, the keys that show alphabetic characters may be changed, but the keys showing commands (e.g., a microphone to provide voice input, a key to switch to a numeric keypad) may remain the same. All the labels may also be changed, but some labels may be no different between keyboards, and thus may appear not to have changed.

For some devices, a user may swipe up-and-down and left-and-right in order to indicate different input intents. The user's device can interpret an up-and-down swipe, for example, as a command to change from alphabetic input characters to non-alphabetic input characters (e.g., a number pad, a Greek character keypad, macro buttons, and voice IME below). A side-to-side swipe can, in contrast, be interpreted as a command to change character sets (other configurations of Roman characters such as Dvorak to the right and non-Roman characters such as Pinyin to the left). In some cases, downward swipes are reserved for closing the keyboard window, and only upward swipes are used for selecting IMEs. Thus, lateral swipes on a particular key may be used to change the keyboard language as shown in the figures, while an upward swipe on the key may be used to change to a numeric keypad, and a downward swipe anywhere on the keyboard may be used to hide the keyboard.

The starting point, ending point, and/or direction of a swipe can be used to indicate different functionality. A swipe starting on a key and swiping in one direction (e.g., left) may be a command to press that key with a modifier key (e.g., Alt) and swiping in another direction (e.g., right) can be a command to press that key with a different modifier key (e.g., Ctrl). A swipe that starts or ends at a particular key can be a command to load a different keyboard (e.g., swipes starting or ending on the C key load a Cyrillic keyboard). A macro, text string, or D-pad directional input can also be assigned to a series of keys, and a swipe that starts or ends on or near those keys can be interpreted as a command to execute the macro or enter the text string. For example, if a user has a password that is difficult to type into the mobile device, it could be assigned to a sequence of letters that are more easily swiped through.

Macros, key combinations, and other swipe settings can be set by a user through an online interface that is displayed on computing devices other than the mobile device shown here, such as a desktop or laptop computer that have a standard size physical keyboard and mouse. An online account associated with the user can stored settings for swipe behavior, such as by correlating swipes on particular keys on a mobile device with hot key combinations for the corresponding keys on the user's desktop or laptop computer. The user's preferences can be received and stored, for example in a hosted storage service (e.g., “the cloud”) and synced to one or more of the user's mobile devices.

The user may also be allowed to configure the keyboards that will be presented to them when they show an intent to switch keyboards. In some implementation, a web page with a series of input fields and controls can be presented to the user. In one control, a user can create an ordered list of keyboards to be used on the mobile device, specifying one of the keyboards as the default. The list of keyboards can include alpha keyboards, numeric keypads, keypads of custom buttons, voice input, handwriting recognition, etc.

In yet another control, custom text strings, such as commonly used but long template text and complex passwords, can be associated with swipes. For example, a swipe can be assigned to signature template text (“Sincerely, Name”). A swipe or series of swipes that start, end, or pass through a keys or reference points in the IME can also be assigned to password text. The password swipe can be restricted to input fields that mask input and prevent copy/paste functionality to avoid inadvertently displaying the password.

As discussed above, a user's desktop or laptop operating system or settings can be associated with an online user account that is also associated with one or more mobile devices. The operating system, or an application executing on the user's desktop or laptop, can monitor user settings, macros, and template text and store that input information on the user's online account. This input information can be synced to some or all of the user's devices including the user's mobile devices. Some optional, system specific, modifications can be made to the user's input information. For example, if a user binds Alt+S to a web search function, Alt+S+I to a web image search function and Ctrl+S to a save document function on a standard sized physical keyboard, a swipe starting at the letter S and moving right on a mobile IME can launch the same web search function, a swipe from S to I can launch the same web image search function, and a swipe starting at the letter S and moving left can launch the same save document function. Custom or nonstandard keys (e.g., media controls, quick launch keys, or programmable keys for video games) on the user's keyboard with bound functionality can be stored to the user's account, and a custom IME for the user's mobile devices can be created to mimic the physical keys and execute the same or similar functionality, as appropriate.

Changes in display from one keyboard to another can be accompanied by one or more transition animations. For example, keys or the entire keyboard can rotate 90° or 180°, giving the appearance of a three dimensional object with alternative labels on the sides and back; labels can be wiped off the keys and new labels wiped on; one keyboard can slide in the direction of a swipe to make room for another keyboard that slides in after it; the current keyboard can fade out and the newly selected key board can fade in; and/or a mascot character can briefly appear on screen to manipulate the keyboard into a new configuration. The animation may progress in synchronization with the progress of a user's finger in sliding across the space bar, so that as a user starts to slide, the individual keys may begin to rotate about their central vertical axes in the direction of the sliding, and if the user slides back (right-to-left), the keys may be made to appear to rotate back by a proportional amount. In this way, a user could make each of the keys look like the individual letters on a Wheel of Fortune answer board (before the board was changed to take a tapping input from Vanna White) being turned in unison back and forth.

A user can preview and select a desired transition animation and associated parameters such as speed and color. A change in display from one keyboard to another can also be accompanied by auditory or tactile feedback, such as a beep or vibration.

On some keyboards and keypads, user tap selection is normally detected on a finger up event. This enables a user to tap down, realize the tap is in the wrong position, adjust their finger position, and lift their finger to select the correct key. Where swiping inputs are to be interpreted as alternative inputs (e.g., keyboard changing input), the response may be changed for such keys that have alternative inputs, so that sliding on or off of the key is interpreted as an alternative input rather than as an intent to change the key on which the user intended to tap—though the remaining keys may maintain their normal behavior. Thus, for example, if a user presses the space bar and then slides off the space bar to the right, it can be interpreted as a user intent to switch keyboards. If the user contacts the “A” key, slides to the right, and releases over the “S” key, it can be interpreted as a tap on the “S” key and an intent to enter the letter “S”.

A voice input mechanism can also have a language setting and a start key. The user may tap the start key (which is shown as a microphone in the figures) and begin speaking voice input. The device may submit that input to a remote server system with a language indicator, may receive back corresponding textual data, and may pass the textual data to an active application—where the language indicator may match the language of the keyboard that is currently being displayed on the device, or can alternatively be the default keyboard language for the device. In this manner, voice input may be coordinated automatically to the keyboard input that the user is providing. Also, while the switch to voice input here is indicated by a button on the keyboard, a sliding motion upward on the space bar or other appropriate sliding motion may be used to invoke voice input (as may certain motion-based inputs that involve moving the device to a particular orientation, e.g., upward and vertical as if the device is being raised to the user's mouth).

Using the techniques discussed here then, a virtual keyboard can provide extended functionality in a constrained on-screen space. In particular, additional sets of key labels may be accessed quickly, readily, and naturally by a user of the device, using a gesture (e.g., dragging laterally on the space bar) that would otherwise by unused on a device. Also, alternative dragging motions, such as dragging upward on the spacebar, may be used to invoke options like voice input, so that the key that would otherwise be occupied by a voice icon can instead be used for another purpose. For example, the space bar could be made wider, and thus easier to select by a user.

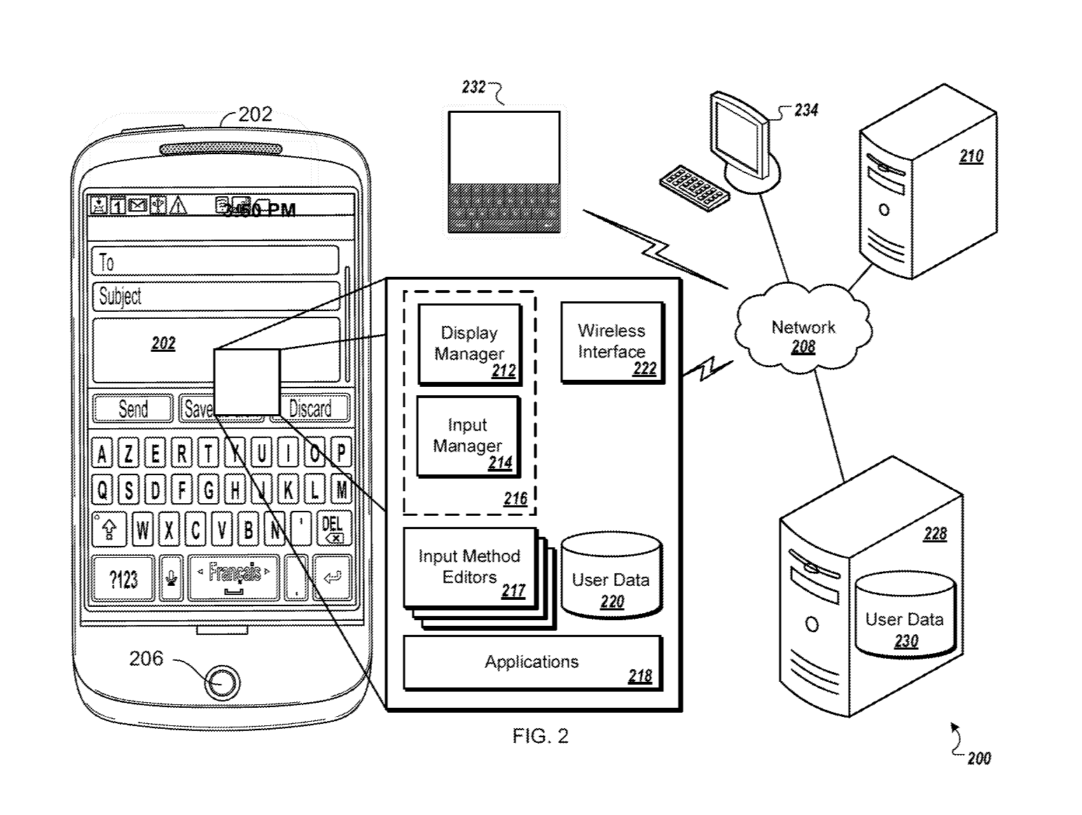

FIG. 2 is a block diagram of a system 200 for providing touchscreen user keyboard input. In general, the system may present virtual keyboards to a user for character-based input, and may provide the user with one or more convenient mechanisms by which to change the labels on the keys of the keyboard.

The system is represented by a mobile device 202, such as a smart phone that has a touchscreen user interface 204. In addition, the device 202 may have alternative input mechanisms, such as a directional pad 206 and other selectable buttons. A number of components within the device 202 may provide for such interaction by the device 202. Only certain example components are shown here, for purposes of clarity.

The device 202 may communicate via a wireless interface 222, through a network 208 such as the internet and/or a cellular network, with servers 210. For example, the device 202 may carry telephone calls through a telephone network or through a data network using VOIP technologies in familiar manners. Also, the device 202 may transmit other forms of data over the internet, such as in the form of HTTP requests that are directed at particular web sites, and may receive responses, such as in the form of mark-up code for generating web pages, as media files, as electronic messages, or in other forms.

A number of components running on one or more processors installed in the device 202 may enable a user to have simplified input on the touchscreen interface 204. For example, an interface manager 216 may manage interaction with the touchscreen interface 204, and may include a display manager 212 and a touchscreen input manager 214.

The display manager 212 may manage what information is shown to a user via interface 204. For example, an operating system on the device 202 may employ display manager 212 to arbitrate access to the interface 204 for a number of applications 218 running on the device 202. In one example, the device 202 may display a number of applications, each in its own window, and the display manager may control what portions of each application are shown on the interface 202.

The input manager 214 may control the handling of data that is received from a user via the touchscreen 204 or other input mechanisms. For example, the input manager 214 may coordinate with the display manager 212 to identify where, on the display, a user is entering information (i.e., where a pointer is contacting the screen) so that that the device may understand the context of the input. In addition, the input manager 214 may determine which application or applications should be provided with the input. For example, when the input is provided within a text entry box of an active application, data entered in the box may be made available to that application. Likewise, applications may subscribe with the input manager 214 so that they may be passed information entered by a user in appropriate circumstances. In one example, the input manager 214 may be programmed with an alternative input mechanism like those shown in FIG. 1 and may manage which application or applications 218 are to receive information from the mechanism.

Input method editors (IMEs) 217 may also be provided for similar purposes. In particular, the IMEs 217 may be a form of operating system component that serves as an intermediary between other applications on a device and the interface manager 216. The IMEs 217 generally are provided to convert user inputs, in whatever form, into textual formats or other formats required by applications 218 that subscribe to receive user input for a system. For example, one IME 217 may receive voice input, may submit that input to a remote server system, may receive back corresponding textual data, and may pass the textual data to an active application. Similarly, another IME 217 may receive input in Roman characters (e.g., A, B, C . . . ) in pinyin, and may provide suggested Chinese characters to a user (when the pinyin maps to multiple such characters), and may then pass the user-selected character to a subscribing application. The IMEs 217 may also interpret swiping inputs on particular keys of a keyboard. The swiping inputs may be used to change the currently displayed keyboard to another keyboard. For example, a swipe to the left or right may cause the IME to scroll the display of keyboard labels from one keyboard to the next in a list. Swipes of a predefined shape or starting, ending, or passing through a particular key or along a particular axis can be used for this scrolling or to change to a particular, preselected keyboard.

Responses to swipe input can be set by the user, either at the device 202 or at another computing device 230. Responses set at the device 202 can be received through a training routine or wizard that gives the user options to select functionality, to record a swipe, and to optionally associate the swipe with all IMEs 217 or only a subset of IMEs 217. These swipe settings can be stored in the user data 220 and synchronized to a user data repository 232 in a user preference server 210 or hosted storage service. The synced settings can be restored to the device 202 in case of deletion (accidental or intentional, such as when upgrading the device 202). Additionally, if the user of the device 202 has other devices that are synchronized with the user data 232, the swipe settings can automatically propagate to the other devices 232 with similar IMEs 217.

Responses to swipe input for the device 202 can be set at a computing station 234 that includes a physical keyboard and/or mouse. For some users, data can be more quickly entered via the physical input devices, cataloged, and then used with swipe inputs to the device 202. For example, a type and sequence of keyboards can be specified at the computing station 234. The type and sequence can be uploaded to the user data 230, then to the user data 220 in the device 202. In response to a user swipe on the device 202, the next type of keyboard in the sequence can be displayed.

In another example, a user can associate a swipe with commands such as hotkeys, macros, or text strings that the user has already established for the station 234. These commands can be uploaded to the user data 230 and synchronized to the appropriate devices. The commands can be specified via a dedicated user interface on a device 202, 232, or 234, or captured from a device 202, 232, or 234 so that other devices mimic the behavior of an already configured device.

Edits to existing mechanisms for switching keyboards or entering similar commands by swiping motions may also be made at the computer station 234. For example, an existing pinyin keyboard can be edited such that the order of suggested Chinese characters is changed to suit a user's particular needs. The personalized pinyin keyboard can be uploaded to the user data 230, synchronized to other devices, and shared with other uses that may have the same needs. In another example, a surveying keyboard that contains a keypad with keys for the ten digits, trigonometric functions, length units and special characters can be defined by a user that uses the device 202 for land surveying. Swipes specific to the surveying keyboard can be defined to input form text used in land plats (e.g., “Beginning at a point”, “thence northerly”, “thence easterly”, etc.). The surveying keyboard can be uploaded to the user data 230 and retrieved by the device 202 for testing by the user. When the user is satisfied with the surveying keyboard, the user can share the keyboard, either by publishing a link to the surveying keyboard in the user data 230, publishing it to a publicly accessible web server, or submitting it to an app store.

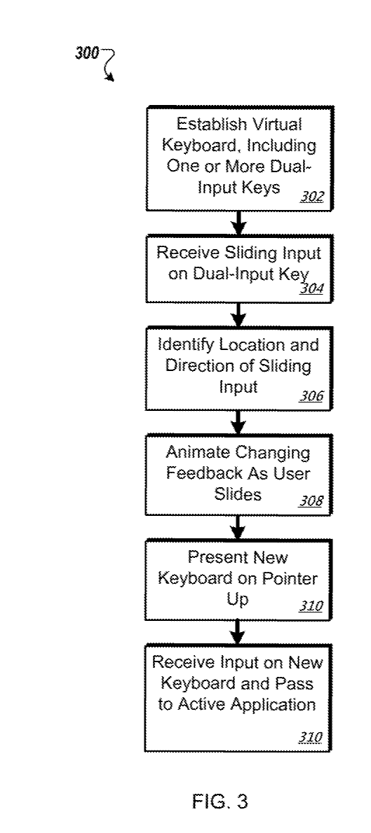

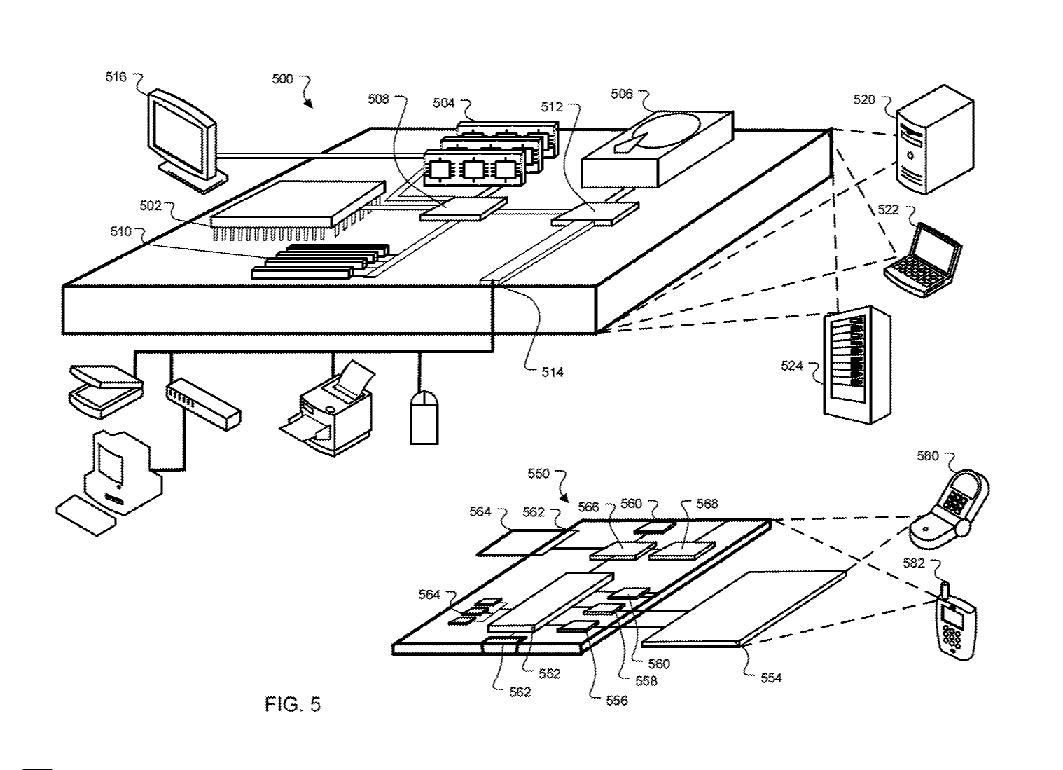

FIG. 3 is a flowchart of a process 300 for receiving touchscreen user inputs. The process can be performed by devices that have touchscreen user interfaces such as the mobile device 200 and, referring to FIG. 5, generic computer device 500 or generic mobile computer device 550. The process 300 can be performed to allow a user to easily switch between two keyboards without interrupting the user's train of thought while using an application on the device.

A virtual keyboard is initially established in the example process, and includes one or more dual-input keys (302). The keys are dual-input because they can exhibit different behaviors based on whether they are tapped or dragged upon. The keys can be arranged according to a standard (e.g., QWERTY, Dvorak), in a language specific arrangement (e.g., Cyrillic or Français), or in a custom arrangement. Some keyboards can have a single character associated with each key (e.g. English), while others can have multiple characters associated with each key (e.g., pinyin).

The virtual keyboard can be one of multiple keyboards stored in a device. Each keyboard can receive input from a user and send corresponding textual input to an active application. Keyboards with letter keys can send the textual input of pressed keys; voice input IMEs can send text strings recognized from user voice input; handwriting input IMEs can receive user-drawn characters and send corresponding text input. The user of a device can select a keyboard to use according to personal preference, based on application specific criteria, or based on input specific criteria. For example, a user writing an email to an English speaking recipient can use a QWERTY keyboard to write the email until the user needs to write a Russian name. The user can then switch to a Cyrillic keyboard to spell the Russian name, and switch back to the QWERTY keyboard to finish the rest of the email.

The switch between keyboards may be made in response to sliding input received on a dual-input key (304). The sliding input can be supplied by the user to indicate a request for a different keyboard. This scheme can create two different classes of input that a user can provide to different software objects in the same device via the same input hardware. A tap—a simple touch and remove of a finger—can associated with text input being sent to an app; a slide—identifiable to a user by the movement on the touchscreen—can be associated with a special control input. This class differentiation can be further facilitated by displaying keyboard metadata (e.g., language) on keys that can receive dual-input so that the user can quickly see which keys have alternative input. Also, a user may provide a particular action, and the keys that have alternative input may be highlighted (e.g., in a contrasting color) so that the user can see which keys have been pre-programmed.

The location and direction of the sliding input is then identified (306). A slide can be defined as a user placing a single finger on one location on the keyboard, sliding the finger to another identifiably different location without losing contact, and removing the finger. These three features, pointer down, slide, and pointer up, can be used by the device to parameterize a sliding input. Particular mechanisms for distinguished and categorizing certain types of input gestures are well-known.

Changing feedback is animated in the process as the user slides their finger along or from the key that they initially contacted (308). The parameters of a slide can be used to determine the type of action taken by the device and the kind of corresponding feedback shown. For example, a slide with a pointer down at the spacebar can indicate a switch to an adjacent keyboard is a list, and a slide starting at a particular letter can indicate a switch to a particular keyboard (e.g., “P” for pinyin, Q for QWERTY). The speed, direction, or distance of a slide can indicate a scroll position in a window of keyboard options. A pointer up event can indicate user selection of an option shown in the window, even if the pointer up event is received on a different key than the pointer down event. While feedback animation (e.g., a window to indicate the language of the currently-selected keyboard, and/or animated transitions of the labels on the key faces) is being shown, the rest of the display can be altered. The rest of the keyboard or the rest of the device display can darken and fade to black, or the keyboard can be closed and the feedback animation can be displayed over an active application.

A new keyboard is thus presented on the occurrence of a pointer up event (310). The feedback animation can transition into a keyboard change animation, or a new animation can be started to display a new keyboard. If the keyboard was changing as the user slid their finger, the new keyboard can simply be locked into place and activated. Various other effects may be shown: a darkened or faded keyboard can also be replaced and brightened; each key can rotate around a virtual vertical axis; a closed keyboard can be reopened; the replaced keyboard can slide off-screen, and the new keyboard can slide onscreen, either from the same side or a different side; and the tops of keys can fold down to scroll through a list of labels, mimicking a flip clock.

The speed, quality, and presence of the animations can be controlled according to user preference and device resources. Users that value aesthetics can specify more, slower, and more complex animations. Users that value speed or devices with limited free computational resources can specify fewer, faster, and less complex animations. The animations for key label switching can also be coordinated with a theme for the user's operating system, and can be downloaded from third parties, as with other theme components.

With the new keyboard in place, input on the new keyboard is received and passed to the active application (310). Such input may be handled by an IME for the operating system that intercepts various forms of user inputs and converts them into a form (e.g., Unicode code) that can be used by the various applications that execute on the device. The user can, for example, tap one of the keys on the new keyboard in order to enter characters that are displayed on the new keyboard. User intentions for the input (e.g., text associated with a tapped key, speech input in addition to the tap that has been examined by a remote server) can then be converted to text. An active application subscribing to IME can then receive the textual input.

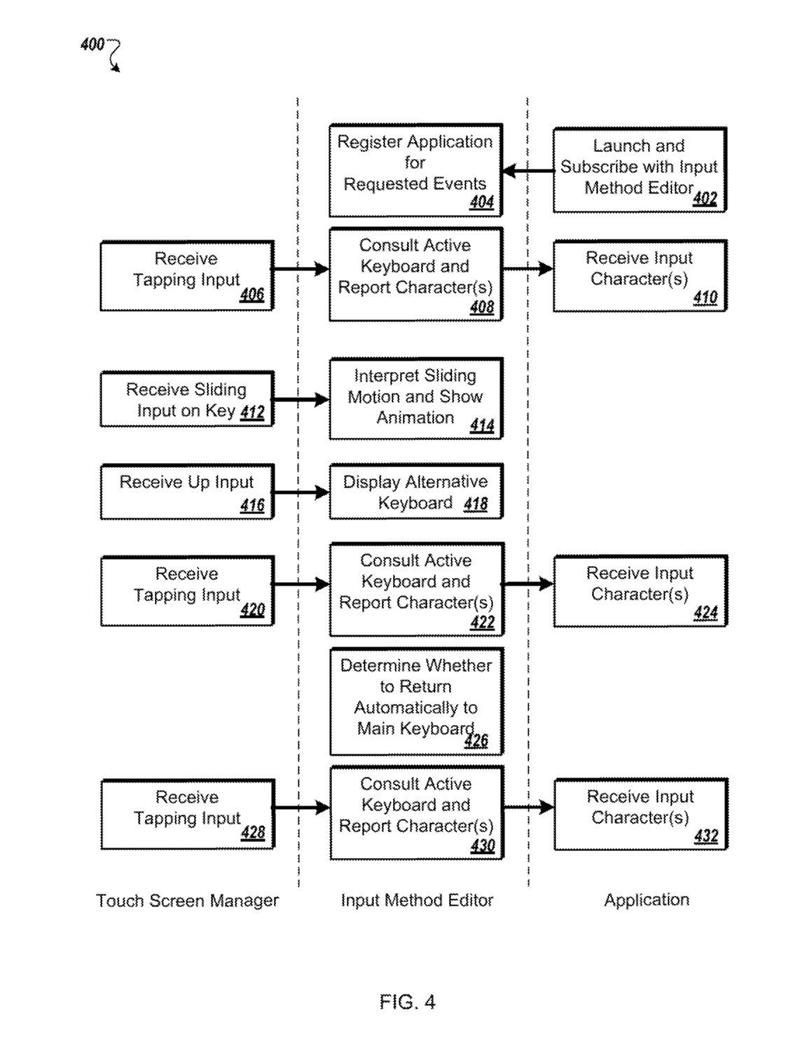

FIG. 4 is a swim lane diagram of a process 400 by which a gesture tracking module interfaces between a computer application and a touchscreen. In general, the process 400 shown here is similar to the process 300 just discussed, though particular examples are shown to indicate which components in a system can perform particular parts of the process 400.

The process starts with an application launching and subscribing with an input method editor (402). The application may be any appropriate application with which a user would want to interact and to which the user would provide textual input. Subscription by the application allows the IME to know to send data to the application when the application is the active application on the device, such as by the IME registering the application for the requested events (404). The IME can, for example, monitor the state of the application to determine the type of input field that is selected, and may cause a virtual keyboard to be displayed when the user has placed a cursor in a area where textual input is expected. When multiple appropriate keyboards are available, user settings or application settings can determine a default keyboard to display.

A touch screen manager then receives tapping input (406). During the course of user interaction with the application, the user may tap a key in the keyboard to send a character or string of characters to the application. For example, the user may tap a spacebar if they desire to send a space character to the application. The IME may interpret the tapping in a normal manner and may send data for the selected characters to the application (408).

The application then receives the input character(s) 410 from the IME. The input characters can be shown in a text field, masked with placeholder asterisks in an input field, or used as a command to perform a function within the application. In this manner, the user can enter text into an application in an ordinary and well-known manner

At some point, such as after a user has entered a number of characters, the user may find that the keyboard does not present a character that they want to input. The touch screen manager thus receives sliding input on a key (412), as the user slides their finger laterally across the key such as the space bar. In performing the action, the user may place a single finger on the space bar and begin to swipe to the right or left in order to request a different keyboard.

The IME then interprets the sliding motion and shows an animation (414). For example, as the user slides, a window can be displayed that shows keyboard options that the user may select. The options may be displayed, for example, as a textual label. The window can be animated with shadings and distortions to appear to be a two dimensional projection of a three dimensional object, such as a wheel or barrel that rolls to scroll and display new options. The window can include a pointer so that the user can determine which option is being selected when they stop the slide. The animation may also include changing the appearance of the keys to be displayed on the new keyboard, in manners like those described above.

The touch screen manager receives an up input or event (416), indicating that the user has removed his or her finger when the desired keyboard has been displayed in line with the pointer. The up input can be on any point on the touchscreen, not necessarily on the same key as where the sliding input was started. The device may interpret the release or up input as a user intent to switch to the particular keyboard that was displayed to the user in the window when they release the pointer from the screen.

The IME then displays an alternative keyboard (418). The current keyboard can be changed to the selected keyboard when the user stops the slide input and lifts his or her finger. This change can include simply replacing the initial keyboard display with the new one, or can involve an animation that transitions from the initial keyboard to the alternative keyboard. The alternative keyboard can be visually altered to display a keyboard label, such as the name or language of the keyboard, which may be shown on the space bar.

The touch screen manager then receives tapping input (420) on the second keyboard. The user may tap on a key to input the associated text character(s). The associated character(s) may be one(s) that were not available on the first keyboard or may have been one that was difficult to access.

The input method editor then consults with the active keyboard and reports characters(s) 422. The positions of particular characters on each key board may be mapped, and the IME may consult the map for the current keyboard in order to determine which character to report to the currently active application when a user taps on the keys.

The application then receives input character(s) 424 form the IME as they are typed by the user. Similar to the step 410, the input characters can be shown in a text field, masked with placeholder asterisks in an input field, or used as a command to perform a function within the application. In some configurations, the application needs not be alerted or request to know that the input character(s) were received through a different keyboard than the characters received in the step 410.

At box 426, the IME determines whether to return automatically to the main keyboard (426). Some keyboards, devices, or user settings can specify that alternative keyboards are only for use for a single character input, and then the main or original keyboard should be displayed. For example, a user may decide that they rarely use voice input or macro keys repeatedly, and may set the IME to return to the default keyboard after each use of the voice input and macro keyboard.

The touch screen manager then receives tapping input (428) on the original keyboard. The original keyboard can be returned, either automatically after a single input in the alternate keyboard or after the user supplies a sliding keyboard to return to the original keyboard. The IME then determines what keyboard is the active keyboard and reports character(s) 430. The IME can look up the associated character(s) in a table or mapping, either the same as the one used in the step 408, or a different table.

The application then receives the input character(s) 432. Similar to the step 424, the application needs not be alerted or request to know which keyboard the input character(s) were received through. Such a process may continue indefinitely, as a user continues to enter characters on a virtual keyboard, and may repeatedly shift keyboards as necessary.

By this process then, a user may be provided with an ability to expand the characters and other inputs they provide by way of a virtual keyboard application. The ability to do so may be natural, in that a user may shift from tapping keys, to sliding across a key such as the space bar, and back to tapping keys again with minimal motion and disturbance. Also, the motion is relatively natural and easy to remember so that a user may invoke the action without having to think about it. Moreover, various addition actions may be assigned to swiping from, to, or across various other keys on a keyboard, and the actions may be coordinated with actions already assigned to a user's hot keys on their main computer, so that the user may execute advanced functions without having to relearn a new system.

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. For example, much of this document has been described with respect to a telephone dialing application, but other forms of applications and keypad layouts may also be addressed, such as keypads involving graphical icons and macros, in addition to alphanumeric characters.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A computer-implemented touch screen user interface method, the method comprising:
displaying a plurality of keys of a virtual keyboard on a touch screen computer interface, wherein the keys each include initial labels and a first key has multi-modal input capability that includes a first mode in which the key is tapped and a second mode in which the key is slid across;
identifying an occurrence of sliding motion by a user on the touch screen and over the first key;
determining modified key labels for at least some of the plurality of keys; and
displaying the plurality of keys with the modified labels in response to identifying the occurrence of sliding motion on the touch screen and over the first key.

2. The method of claim 1, further comprising animating a transition from the initial labels to the revised labels while the sliding motion occurs.

3. The method of claim 2, wherein the animated transition comprises wiping the initial labels off the keys as the sliding motion progresses, while maintaining outlines for the keys stationary.

4. The method of claim 3, wherein the animated transition comprises wiping the modified labels onto the keys as the initial labels are wiped off the keys.

5. The method of claim 2, wherein the animated transition comprises visually rotating each of the keys to visually changed from first surfaces of the keys displaying the initial labels to second surfaces of the keys displaying the modified labels.

6. The method of claim 1, further comprising determining which axis, of a plurality of axes, the sliding motion is occurring along, and selecting a group of modified labels based on the determination of which axis the sliding motion is occurring along.

7. The method of claim 6, further comprising selecting a group of modified labels that is primarily non-alphabetic labels if the sliding motion is determined to occur along a first axis, and selecting a group of modified labels that is primarily alphabetic labels if the sliding motion is determined to occur along a second axis that is different than the first axis.

8. The method of claim 1, further comprising displaying, near the first key and while identifying the occurrence of a sliding motion, an icon that describes a label type to be applied to the plurality of keys if the sliding motion were to stop immediately.

9. The method of claim 1, further comprising identifying an occurrence of sliding motion in a direction opposite the first direction, and, as a result, displaying the plurality of keys with the initial labels.

10. The method of claim 1, wherein the initial labels represent characters in a first language and the modified labels represent characters in a second language.

11. The method of claim 1, further comprising receiving a user tap, or press, input on the first key and providing, with an input method editor and to an application that is subscribed to the input method editor, data for a character that corresponds to a current label on the first key.

12. The method of claim 1, further comprising providing a tactile feedback to register, with the user, reception of the sliding motion as a recognized keyboard-changing input.

13. The method of claim 1, further comprising coordinating data for providing sliding input on keys of a first computing device that corresponds to a user account, with data for providing hot-key input on corresponding keys of a second computing device that corresponds to the user account.

14. A computer-implemented touch screen user interface system, the system comprising:
a touch screen to display on a mobile computing device a virtual keyboard having a plurality of keys;
an input manager to receive and interpret user inputs on a touchscreen of a computing device, including tapping inputs and dragging inputs;
a gesture interface programmed to interpret a tapping input on a first one of the keys as a user intent to enter a character currently being displayed on the touch screen on the first one of the keys, and to interpret a dragging input across the first one of the keys as a user intent to change labels on at least some of the keys.

15. The computer-implemented system of claim 14, wherein, the gesture interface is further programmed to determine which axis, of a plurality of axes, the sliding motion is occurring along, and to select a group of modified labels based on the determination of which axis the sliding motion is occurring along.

16. The Computer-implemented system of claim 15, wherein the gesture interface is further programmed to select a group of modified labels that is primarily non-alphabetic labels if the sliding motion is determined to occur along a first axis, and to select a group of modified labels that is primarily alphabetic labels if the sliding motion is determined to occur along a second axis that is different than the first axis.

17. The computer-implemented system of claim 14, wherein the gesture interface is programmed to cause a display interface to cause an animated transition to be provided during a dragging motion on the first one of the keys, showing a change from a first set of labels on at least some of the plurality of keys to a second, different set of labels on the at least some of the plurality of keys.

18. The computer-implemented system of claim 17, wherein the animated transition comprises wiping the initial labels off the keys as the sliding motion progresses, while maintaining outlines for the keys stationary.

19. The computer-implemented system of claim 17, wherein the animated transition comprises visually rotating each of the keys to visually changed from first surfaces of the keys displaying the initial labels to second surfaces of the keys displaying the modified labels.

20. The computer-implemented system of claim 14, wherein the gesture interface is further programmed to cause a display, near the first one of the keys and during a dragging input, of an icon that describes a label type to be applied to the plurality of keys if the dragging motion were to stop immediately.

21. A computer-implemented touch screen user interface system, the system comprising:
a touch screen to display on a mobile computing device a virtual keyboard having a plurality of keys;
an input manager to receive and interpret user inputs on a touchscreen of a computing device, including tapping inputs and dragging inputs;
means for changing a display of labels on the plurality of keys in response to sensing a dragging motion across one of the plurality of keys.
